(19) United States
(12) Patent Application Publication
(10) Pub. No.: US 2025/0329863 A1
(43) Pub. Date: Oct. 23, 2025

(54) SEALED BATTERY ENCLOSURE

(71) Applicant: GM GLOBAL TECHNOLOGY OPERATIONS LLC, Detroit, MI (US)

(72) Inventors: Michael Apone, Fraser, MI (US); Ryan Patrick Hickey, Austin, TX (US)

(73) Assignee: GM GLOBAL TECHNOLOGY OPERATIONS LLC, Detroit, MI (US)

(21) Appl. No.: 18/639,080

(22) Filed: Apr. 18, 2024

(51) Int. Cl. H01M 50/342; H01M 50/249; H01M 50/383

(52) U.S. Cl. CPC H01M 50/3425; H01M 50/249; H01M 50/383; H01M 2200/20; H01M 2220/20

(57) ABSTRACT

Battery enclosure systems, methods for venting gases from batteries, and vehicle are provided. A battery enclosure system includes a tray, a cover, an annular inner seal sealing the tray to the cover and defining an inner enclosed chamber and an annular outer enclosed channel, and a battery located in the inner enclosed chamber.

### INTRODUCTION

The disclosure relates to motor vehicle battery systems, and more specifically to systems and methods for enclosing and venting battery packs.

Electrochemical battery packs are used in a host of battery electric systems. Aboard an electric vehicle (EV) in particular, a high-energy propulsion battery pack is arranged on a direct current (DC) voltage bus, with the propulsion battery pack having an application-suitable number of cylindrical, prismatic, or pouch-style electrochemical battery cells. The DC voltage bus ultimately powers one or more electric traction motors and associated power electronic components during battery discharging modes. The same DC voltage bus conducts a charging current to constituent battery cells of the battery pack during battery charging modes.

Propulsion battery packs for use with electric vehicles and other battery electric systems typically utilize a lithium-based or nickel-based battery chemistry. In lithium-ion battery cells, for instance, the movement of electrons and lithium ions produces electricity for use in powering the above-noted electric traction motor(s). Charging and discharging of the battery cells is accompanied by a discharge of heat. The generated heat in turn must be dissipated from the battery cells, e.g., via circulation of battery coolant, cooling plates, or cooling fins. Under rare conditions, battery cell damage, age, or degradation could lead to the generation of heat in a battery cell or battery pack at a rate exceeding an existing cooling capability. Such a condition is referred to both herein and in the art as thermal runaway.

Accordingly, there is a need for systems and methods for enclosing EV batteries which protect adjacent vehicle components from the heat emitted from the battery, while reducing hardware cost and complexity, improving reliability, and offering improved function and redundancy. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a battery enclosure system includes a tray, a cover, an annular inner seal sealing the tray to the cover and defining an inner enclosed chamber and an annular outer enclosed channel, and a battery located in the inner enclosed chamber.

In certain embodiments of the battery enclosure system, the annular inner seal is formed by a gasket.

In certain embodiments, the battery enclosure system further includes an annular outer seal formed by adhesive and connecting a perimeter of the tray to a perimeter of the cover, and the annular outer enclosed channel is located between the annular inner seal and the annular outer seal.

In certain embodiments of the battery enclosure system, the annular inner seal is configured to fail at a first pressure and the annular outer seal is configured to withstand the first pressure.

In certain embodiments, the battery enclosure system further includes an outlet device in communication with the annular outer enclosed channel.

In certain embodiments, the battery enclosure system further includes an outlet device formed in the cover and in communication with the annular outer enclosed channel.

In certain embodiments, the battery enclosure system further includes an outlet device formed in the tray and in communication with the annular outer enclosed channel.

In certain embodiments, the battery enclosure system further includes a manifold interconnected to the annular inner seal, and the annular outer enclosed channel is located between the annular inner seal and the manifold.

In certain embodiments, the battery enclosure system further includes an outlet device formed in the manifold.

In another embodiment, a method for venting gases from a battery includes locating the battery between a tray and a cover, sealing the cover to the tray to form an annular inner seal enclosing an inner chamber, wherein the battery is located in the inner chamber, and wherein the annular inner seal separates the inner chamber from an annular outer enclosed chamber, separating the cover from the tray at a failure location in the annular inner seal due to an increased pressure within the inner chamber, flowing the gases from the inner chamber to the annular outer enclosed chamber at the failure location, and flowing the gases out of the annular outer enclosed chamber through a particulate filter.

In certain embodiments of the method, the annular inner seal is formed by a gasket.

In certain embodiments, the method further includes sealing a cover perimeter of the cover to a tray perimeter of the tray with an adhesive to form an annular outer seal, and the annular outer enclosed chamber is located between the annular inner seal and the annular outer seal.

In certain embodiments of the method, the annular inner seal is configured to fail at the increased pressure and the annular outer seal is configured to withstand the increased pressure.

In certain embodiments, the method further includes forming the particulate filter in the tray and/or cover at a selected location or coupling the particulate filter to the tray and/or cover at a selected location.

In certain embodiments, the method further includes directing flow of the gases through the particulate filter in a desired direction.

In another embodiment, a vehicle includes a battery and a battery enclosure system, and the battery enclosure includes a tray having a tray perimeter, a cover having a cover perimeter, and an annular inner seal connecting the tray perimeter to the cover perimeter and defining an inner enclosed chamber and an annular outer enclosed chamber, wherein the battery is located in the inner enclosed chamber.

In certain embodiments of the vehicle, the annular inner seal is formed by a gasket.

In certain embodiments of the vehicle, the battery enclosure system further includes an annular outer seal formed by adhesive and connecting the tray perimeter to the cover perimeter, and the annular outer enclosed chamber is located between the annular inner seal and the annular outer seal.

In certain embodiments of the vehicle, the battery enclosure system further includes a particulate filter in communication with the annular outer enclosed chamber.

In certain embodiments of the vehicle, the battery enclosure system further includes a manifold interconnected to the annular inner seal, and the annular outer enclosed chamber is located between the annular inner seal and the manifold.

### DESCRIPTION OF THE DRAWINGS

The present disclosure will hereinafter be described in conjunction with the following drawing figures, wherein like numerals denote like elements, and wherein:

FIG. 1 is a schematic, perspective view of an electric vehicle with a cut-away section to reveal a battery housed in a battery enclosure system with an interconnected tray and cover in accordance with exemplary embodiments.

FIG. 2 is a schematic system diagram depicting the battery enclosure system, such as shown in FIG. 1, in accordance with exemplary embodiments.

FIG. 3 is a partial schematic view of the battery enclosure system of FIG. 2, focused on the inner seal and outer seal, in accordance with exemplary embodiments.

FIG. 4 is a partial schematic view of a battery enclosure system, similar to FIG. 3, and illustrating alternate structures in accordance with exemplary embodiments.

FIG. 5 is a partial schematic view of a battery enclosure system, similar to FIGS. 3-4, and illustrating alternate structures in accordance with exemplary embodiments.

FIG. 6 is an overhead schematic view of a battery enclosure system of FIG. 2 in accordance with exemplary embodiments.

FIG. 7 is a flow chart illustrating a method for venting gases from a battery in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “of” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

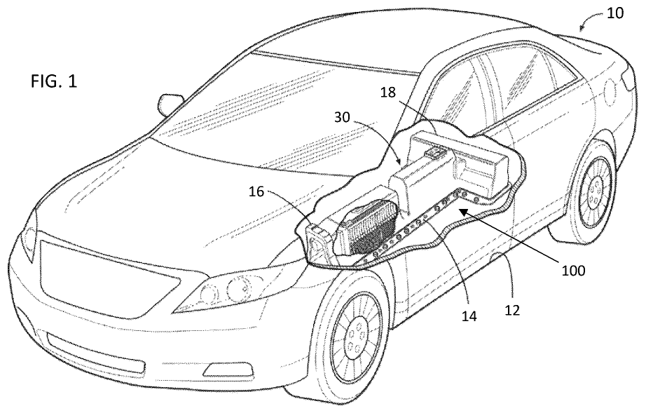

Referring to the drawings, wherein like reference numbers correspond to like or similar components wherever possible throughout the several figures, an electric vehicle 10 having a battery module 10, battery cell 30, or a plurality of battery cells in a battery stack 30, is shown in FIG. 1. The term “battery” used alone herein may refer to a battery module, battery cell or cell stack. The electric vehicle 10 further includes a battery enclosure system 100 for enclosing the battery 30. The term “battery pack” used alone may refer to a battery and the battery enclosure system the battery is housed within.

The electric vehicle 10 includes a vehicle chassis 12. The battery enclosure system 100 includes a battery tray 14. The battery 30 attaches to the battery tray 14, which in turn, attaches to the vehicle chassis 12 to secure the battery 30 to the electric vehicle 10.

The electric vehicle 10 may also include a battery disconnect unit 16, which is connected to the battery 30 and provides electrical communication between the battery 30 and an electrical system (not shown) of the electric vehicle 10.

The battery enclosure system 100 further include a battery cover 18 that extends over and around the battery 30. The battery cover 18 may protect the battery 30 from being damaged, as well as provide electrical insulation to the high voltage of the battery 30.

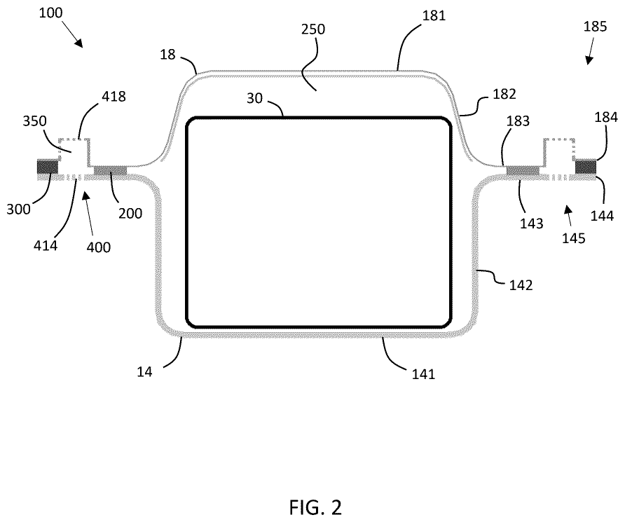

FIG. 2 is a cross-sectional schematic illustrating an exemplary embodiment of the battery enclosure system 100 of FIG. 1. FIG. 2 illustrates that the battery tray 14 of the battery enclosure system 100 includes a base member 141 that extends laterally to sidewalls 142. As shown, the sidewalls 142 extend upward to an annular flange member 143. The annular flange member 143 extends laterally away from the sidewalls 142 to a peripheral outer edge 144 of the battery tray 14. As shown, the annular flange member 143 defines a tray perimeter 145. The battery tray 14 may be a metal such as steel or aluminum or other suitable material.

As shown in FIG. 2, the battery cover 18 includes a base member 181 that extends laterally to sidewalls 182. As shown, the sidewalls 182 extend downward to an annular flange member 183. The annular flange member 183 extends laterally away from the sidewalls 182 to a peripheral outer edge 184 of the battery cover 18. As shown, the annular flange member 183 defines a cover perimeter 185. The battery cover 18 may be a metal such as steel or aluminum or other suitable material. In certain embodiments, the battery cover 18 may be non-metal and/or may be formed from a composite material.

FIG. 2 further illustrates that the tray perimeter 145 and cover perimeter 185 are sealed together adjacent to outer edge 144 and outer edge 184 by an outer seal 300. For example, the outer seal 300 may be an adhesive, such as a room-temperature-vulcanizing (RTV) adhesive. An exemplary adhesive for forming the outer seal 300 is a silicone or polymer or other material able to withstand the high temperature environment of the battery 30. The outer seal 300 is annular and continuous.

FIG. 2 also illustrates that the tray perimeter 145 and cover perimeter 185 are sealed together by an inner seal 200. For example, the inner seal 200 may be a mechanical seal, such as a gasket. For example, the inner seal 200 may be a press-in-place compression gasket. An exemplary inner seal 200 is a static seal. An exemplary inner seal 200 is annular and continuous. During assembly, the inner seal 200 may be formed by locating mating gasket sides on the tray 14 and cover 18, by aligning such gasket sides, and by pressing the gasket sides together.

In an exemplary embodiment, the outer seal 300 is configured to withstand a higher pressure than the inner seal 200. Specifically, at a selected elevated pressure the inner seal 200 will fail when the battery cover 18 separates from the battery tray 14 at a failure location. At the same elevated pressure, the outer seal 300 remains intact, connecting the battery cover 18—to the battery tray 14 continuously around the perimeters 145 and 185. In certain embodiments, the selected elevated pressure at which the inner seal 200 fails may be 20 kilopascal (kPa), though the selected elevated pressure may be any suitable pressure that may occur during a failure event, such as during thermal runaway.

While the inner seal 200 is configured to fail at an elevated pressure, such as during a thermal runway event, the inner seal 200 is configured to remain sealed at typical operating pressures of the battery cell or battery 30, such as at pressures less than 20 kilopascal (kPa).

The inner seal 200, sidewalls 142 and 182, and base members 141 and 181 define and enclose an inner chamber 250. As shown, the battery 30 is located in the inner chamber 250.

The outer seal 300, flange members 143 and 183, and inner seal 200 define an annular outer chamber or channel 350. The inner seal 200 separates the inner chamber 250 from the annular outer channel 350.

With the described structure, the battery enclosure system 100 is configured such that when the inner seal 200 fails at a failure location, gas at a relatively higher pressure within the inner chamber 250 flows through the inner seal 200 at the failure location to the annular outer channel 350.

As shown in FIG. 2, the battery enclosure system 100 is further provided with an outlet device 400 such as a vent channel, a particulate filter, spark arrestor, and/or other spark or fire reduction device. Each outlet device 400 is located outside of the inner seal 200, relative to the inner chamber 250. The outlet device 400 may be formed in or coupled to the battery tray 14 (as outlet device 414) and/or may be formed in or coupled to the battery cover 18 (as outlet device 418) and configured to receive gas or fluid from the annular outer channel 350. The outlet device 400 may be stainless steel or other material suitable for withstanding high temperatures and pressures. In certain embodiments, the device 400 is formed in the battery tray 14 and/or battery cover 18. For example, a pattern of voids or openings may be punched into the battery tray 14 and/or battery cover 18 to form a mesh or filter. The voids may be formed with a critical dimension or diameter configured to capture solid particles exiting with the vent gas from the annular outer channel 350.

In certain embodiments, outlet devices 400 are located continuously around the perimeter 145 or 185 of the battery tray 14 and/or battery cover 18. In other embodiments, outlet devices 400 may be spaced circumferentially around the perimeter 145 or 185 of the battery tray 14 and/or battery cover 18. For example, outlet devices 400 may be located at two, three, four, five, six, or another suitable number of locations. In certain embodiments, the outlet devices 400 may be equally spaced from one another. Alternatively, devices 400 may be located at selected locations to direct vent gases away from the battery enclosure system 100 toward a preferred direction, i.e., away from other vehicle components that may be vulnerable to the heat of vent gases exiting the device(s) 400. In such embodiments, the locations of outlet devices 400 may not be symmetrical about the perimeters 145 and 185 of the battery tray 14 and battery cover 18. Further, it is noted that outlet devices 400 are not required on all flange surfaces, and may be located only where desired, i.e., outlet devices 400 may be present only on the battery tray 14 or only on the battery cover 18.

The structure of the flanges 143 and 183 may be designed to direct flow of vent gases through the device(s) 400 in desired directions. For example, the shape of the flanges may include bends or other geometry to align outlet devices 140 in a desired orientation to direct flow of vent gases therefrom in a desired direction.

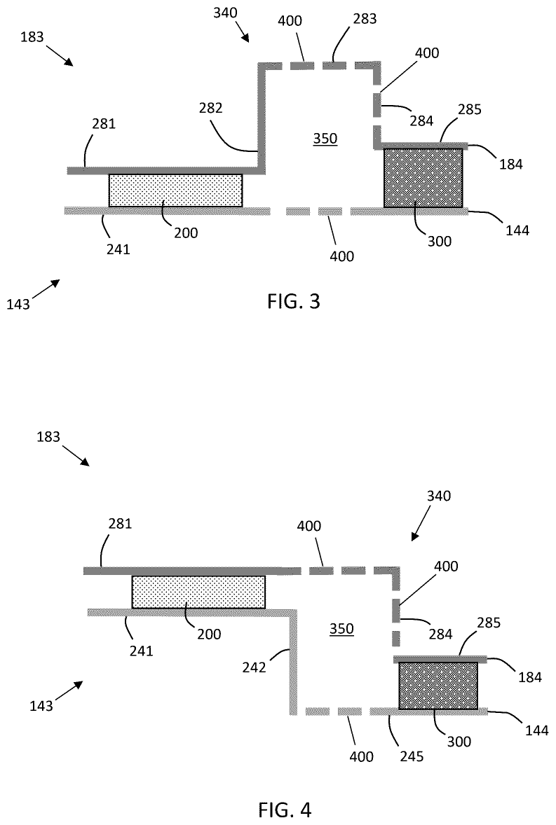

FIG. 3 provides a focused view of the flanges 143 and 183, and annular outer channel 350 of the battery enclosure system 100 of FIG. 2. In the embodiments of FIGS. 2 and 3, the flange 143 of the battery tray 14 is substantially planar, i.e., an annulus or flat ring-shaped. The battery tray flange 143 may include a single annular wall 241 that extends to the edge 144.

As shown, the flange 183 of the battery cover 18 includes a bend, i.e., is formed with a projection 340 that extends away from the flange 143. As a result, the annular outer channel 350 lies entirely above the plane of the flange 143. As shown, the battery cover flange 183 may include a wall 281 that is an annulus or flat ring-shape. Wall 281 extends laterally to a sidewall 282 that may be cylindrical. The sidewall 282 extends away from the tray flange 143 and connects to an end wall 283. The end wall 283 may be an annulus or flat ring-shape and extends laterally to a sidewall 284. The sidewall 284 may be cylindrical. The sidewall 284 extends toward the tray flange 143 and connects to an end wall 285. The end wall 285 terminates at the outer edge 184 and may be an annulus or flat ring-shape. As shown, the inner seal 200 is mounted on and between the wall 281 and the wall 241. Further, the outer seal 300 is mounted on and between the wall 285 and the wall 241. The annular outer channel 350 is bounded by the inner seal 200, wall 241, outer seal 300, wall 285, sidewall 282, end wall 283, sidewall 282, and wall 281. By selectively forming a device 400 on one of the sidewalls 282 or 284, and/or on end wall 283 or wall 241, the direction of flow of vent gases out of the device 400 may be controlled. As may be seen from FIG. 3, the angle of any of walls 282, 283, and 284 may be designed to orient an outlet device 400 formed thereon to vent gases in a desired direction.

FIG. 4 illustrates another embodiment of the structure of flanges 143 and 183 and annular outer channel 350 of the battery enclosure system 100. In FIG. 4, each of flanges 143 and 183 include a bend, such the projection 340 is formed by a non-planar battery tray flange 143 and a non-planar battery cover flange 183.

As shown the battery tray flange 143 includes a wall 241 that is an annulus or flat ring-shape. Wall 241 extends laterally to a sidewall 242 that may be cylindrical. The sidewall 242 extends away from the cover flange 183 and connects to an end wall 245. The end wall 245 may be an annulus or flat ring-shape and extends laterally to outer edge 144.

Likewise, the battery cover flange 183 includes a wall 281 that is an annulus or flat ring-shape. Wall 281 extends laterally to a sidewall 282 that may be cylindrical. The sidewall 282 extends toward the tray flange 143 and connects to an end wall 285. The end wall 285 may be an annulus or flat ring-shape and extends laterally to outer edge 184.

As shown, the inner seal 200 is mounted on and between the wall 281 and the wall 241. Further, the outer seal 300 is mounted on and between the wall 285 and the wall 245. The annular outer channel 350 is bounded by the inner seal 200, wall 241, sidewall 242, wall 245, outer seal 300, wall 285, sidewall 284, and wall 281. By selectively forming a device 400 on one of the sidewalls 242 or 284, and/or on wall 281 or wall 245, the direction of flow of vent gases out of the device 400 may be controlled. Again, it is noted that the walls 241, 242, 245, 281, and 284 may be formed at any desired angle to provide outlet devices 400 formed thereon with a desired outlet flow direction.

While FIGS. 2-4 illustrate two structural designs for enclosing the annular outer channel 350 with the battery tray flange 143 and battery cover flange 183, other arrangements are contemplated.

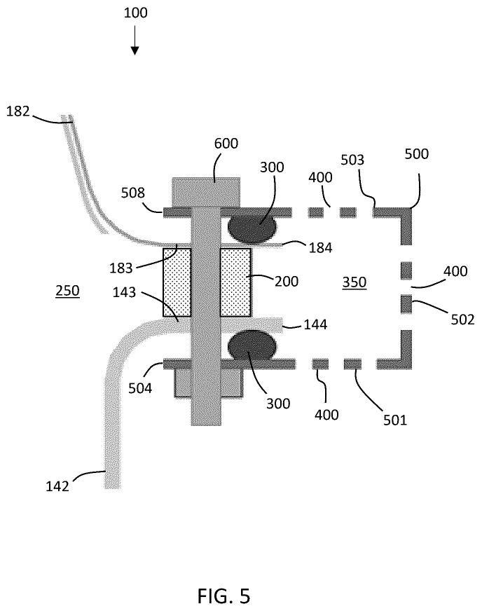

FIG. 5 illustrates another embodiment of a battery enclosure system 100 with the inner seal 200 interconnecting the battery tray flange 143 and battery cover flange 183. In FIG. 5, the battery tray flange 143 is sealed to the battery cover flange 183 by the inner seal 200. As shown, an enclosure structure 500, such as an annular manifold, may be connected to the sealed flanges 143 and 183 via fasteners 600. For example, a mechanical fastener 600, such as a bolt and nut, may secure the enclosure structure 500 to the sealed flanges 143 and 183. Fasteners 600 may be spaced circumferentially around the battery tray 14 and battery cover 18. The enclosure structure 500 may include outlet devices 400, such as spark arrestors or vent channel hardware.

As shown, the enclosure structure 500 may extend from an end 504 located below the battery tray flange 143 to an end 508 located above the battery cover flange 183. The enclosure structure 500 may include a bottom member 501 that extends laterally outward from the end 504 to an end member 502. As shown, the end member 502 may extend upward from the bottom member 501 to a top member 503. Further, the top member 503 member may extend laterally from the end member 502 to the end 508. The bottom member 501 and top member 503 may each be an annulus or ring-shaped. The end member 502 may be cylindrical or planar.

As shown, the bottom member 501 may be sealed to the battery tray flange 143 near outer edge 144, and the top member 503 may be sealed to the battery cover flange 183 near outer edge 184, by outer seals 300. In certain embodiments, each outer seal 300 is a cure-in-place gasket or another suitable sealing mechanism. In certain embodiments, each outer seal 300 is formed by an adhesive.

As shown, outlet devices 400 may be formed on bottom member 501, end member 502, and/or top member 503. By selectively forming devices 400 at desired locations, the direction of flow of vent gases out of the device 400 may be controlled. The bottom member 501, end member 502, and top member 503 may be formed at any desired angle to provide outlet devices 400 formed thereon with a desired outlet flow direction.

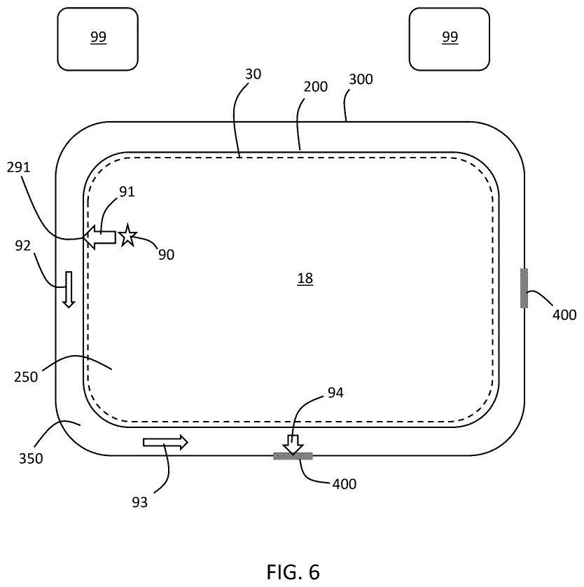

FIG. 6 is a top view schematic illustrating the flow path of vented gases from an overheat location to an outlet from the battery enclosure system 100. As shown, the cover 18 and tray 14 (hidden by cover 18) are sealed together at inner seal 200 and at outer seal 300. Inner seal 200 bounds an inner chamber 250 in which the battery 30 is located. Inner seal 200 and outer seal 300 bound an annular outer channel 350. An outlet device 400 for venting gases is formed in communication with the annular outer channel 350.

When an overheating incident, such as thermal runaway, occurs at a location 90 in the battery 30, a localized temperature increase occurs and pressure increases. The increase in temperature and pressure causes a failure of the inner seal 200 at a failure location 291. As a result, heated gases flow in the direction of arrow 91 out of the inner chamber 250 and into the annular outer channel 350. As shown, the heated gases may flow in the direction of arrows 92 and 93 to the nearest outlet device 400. Then, the heated gases may exit the battery enclosure system 100 through outlet device 400 as indicated by arrow 94.

As shown, after exiting the inner chamber 250, the heated gases are separated from the other battery components by the remaining inner seal 200 that has not opened. Thus, other battery components may be protected from the heat of the heated gases and damage to the battery 30 may be minimized. Further, selection of the location and orientation of the outlet devices 400 may direct the vented gases in the direction of arrow 94 away from vulnerable vehicle components 99.

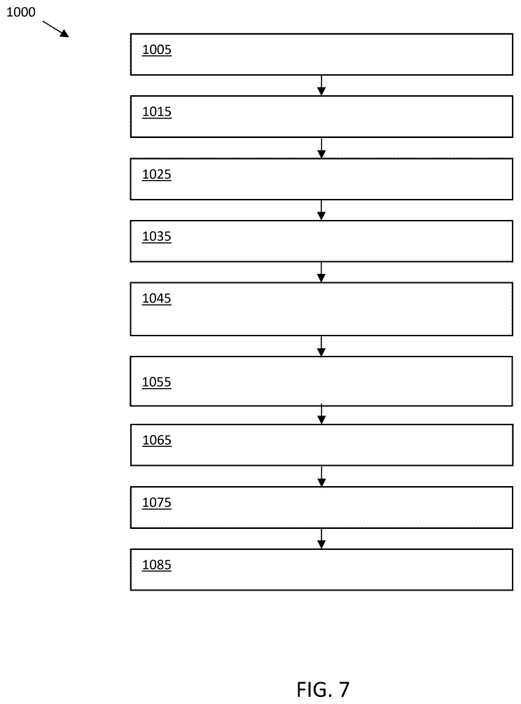

FIG. 7 illustrates a method 1000 for venting gases from a battery.

Method 1000 includes, at operation 1005, locating the battery between a battery tray and a battery cover.

Method 1000 includes, at operation 1015, sealing the battery cover to the battery tray to form an annular inner seal enclosing an inner chamber. After sealing the battery cover to the battery tray, the battery is located in the inner chamber.

Method 1000 may further include, at operation 1025, sealing a perimeter of the battery cover to a perimeter of the battery tray to form an annular outer seal.

Method 1000 may also include, at operation 1035, forming a device, such as a particulate filter, in the battery tray and/or battery cover at a selected location or coupling a device such as a particulate filter, to the battery tray and/or battery cover at a selected location. It is noted that the order of operations of FIG. 7 is not limited by the illustration. For example, the device may be formed in the battery tray and/or battery cover or coupled to the battery tray and/or battery cover before operation 1005, before operation 1015, and/or before operation 1025.

Method 1000 may include, at operation 1045, operating a vehicle using power from the battery.

Method 1000 includes, at operation 1055, separating the battery cover from the battery tray at a failure location in the annular inner seal due to an increased pressure within the inner chamber. For example, a thermal runaway incident may cause an increase in temperature and pressure, causing the annular inner seal to fail at a failure location.

Method 1000 includes, at operation 1065, flowing vent gases from the inner chamber to the annular outer enclosed chamber at the failure location.

Method 1000 includes, at operation 1075, flowing the vent gases out of the annular outer enclosed chamber through an outlet device, such as a particulate filter. The outlet device may catch particulate in the vent gases to avoid contact of the particulate with oxygen and a resulting ignition.

Method 1000 may include, at operation 1085, directing flow of the vent gases through the particulate filter in a desired direction, such as away from vulnerable vehicle components.

As described herein, a battery enclosure system provides for protection of internal battery components during an overheating situation by providing for designed failure of an inner seal at a failure location. In certain embodiments, the failure location is nearest the overheating location. Further the designed failure provides for flowing heated gas out of the inner chamber where the battery is located and into an annular outer channel. The battery remains protected from heated gases in the annular channel by the remaining inner seal that has not failed. Additionally, an outlet device is, or outlet devices are, located in communication with the annular outer channel to expel the heated gases from the battery enclosure in a desired direction, such as away from other vehicle components.

Also, it is noted that, due to the structural design of the battery enclosure system, the outer seal may be cut open during servicing without damaging the battery pack. Specifically, the outer seal is distanced from the battery pack and high voltage components therein, and the inner seal is located between the outer seal and the battery pack. Thus, ease of servicing may be provided as compared to existing systems.

Certain embodiments herein include a full-pack seal provided by an inner seal to improve the venting performance of the battery pack or module while mitigating the flaws of existing full-pack seals. Specifically, full-pack adhesive seal placement may lead to damaged internal pack components during service, i.e., while cutting through the adhesive seal to service internal components. Herein, a full-pack compression gasket may be implemented for improved serviceability. During rapid thermal runaway propagation (TRP), the battery tray or battery cover flanges may deform due to elevated internal pressures and temperatures in the pack causing failure of the inner seal. This failure is counteracted herein by using an outer seal between the battery tray and battery cover that forms a channel with the inner seal. Thus, when heat and pressures within the battery pack rise, compression in the inner seal gasket is lost and the inner seal fails and creates a leak path for dangerous hot gases to exit the pack. Herein, the hot gases are directed along the channel within the outer seal to an outlet device. The outlet device may include a particulate filter, spark arrestor, or venting system. The outlet device may function to evacuate the hot gases from the outer channel. Thus, failure of the inner seal gasket during a TRP event may occur without heated particles escaping the battery enclosure. As a result, auto-ignition due is avoided.

Certain embodiments herein allow for failure of an inner seal to enable venting capability during TRP.

Certain embodiments herein use the sealing area of the battery tray and battery cover of a battery enclosure as a vent gas exit system. In certain embodiments, the sealing area of the battery tray and the battery cover is used as a vent gas passage to utilize surface area of largest pack components (metal thermal mass) for vent gas cooling. Thus, the area between the inner and outer seals is used as a vent gas passage and passively cools the gases prior to release to ambient. Certain embodiments herein improve heat transfer from hot TRP gases before emitting the gases from the battery enclosure system. Certain embodiments herein improve heat sink utilization of structure with mitigation of heat transfer to vulnerable battery cells in the battery pack.

An increased cross sectional area of venting is provided by utilizing the sealing area rather than small vent locations on the header. Certain embodiments herein use the sealing area as a spark arrestor for a particle management system. Certain embodiments herein stamp out the spark arrestor in the sealing area directly on the battery cover and/or the battery tray. In certain embodiments herein, a spark arrestor or vent channel hardware is added on as separate piece to sealing flange assembly.

In certain embodiments, the annular sealing area (fully around the battery pack) is used for vent gas travel to designed and selected release points to the vehicle. For example, the heated gas may travel in a channel formed in the sealing area to specific location(s) where the vehicle is least susceptible to high temperature gases, i.e., away from sensitive components. An outlet device is located at each specific location to vent the heated gas from the battery enclosure in a preferred direction.

Certain embodiments provide for venting heated gases from the battery pack in more than one direction.

In certain embodiments, the cross-sectional area of venting out of the outlet device, i.e., spark arrestor, is tuned based on vehicle components to allow venting out of the sealed passage in desired locations away from sensitive components.

In certain embodiments, the cross-sectional area of the outlet device, i.e., spark arrestor, is significantly increased from traditional vents to reduce vulnerability to clogging.

In certain embodiments, the flow path of the heated gases from the channel to the outlet device is formed with bend features to enable a designed passageway within the assembled area.

In certain embodiments, heat transfer to neighboring cells/modules is reduced as gases exit the pack to a nearest seal failure location.

Certain embodiments herein enable use of composite battery covers. In such embodiments, the spark arrestor may be formed on the battery tray and vent gas release may be directed away from vehicle components and back onto the battery enclosure external surface.

In certain embodiments, increased pack pressure is allowed during TRP because the gasket seal is not relied on under TRP conditions, while battery pack serviceability is retained.

In certain embodiments, the full-pack inner seal is a low-cost seal or gasket (fabricated from inexpensive “low thermal materials” not sufficient to withstand high thermal conditions) to solely meet normal operation pressure and temperature requirements and allow for failure under TRP.

In certain embodiments, an outer seal connecting the tray and cover seals gases during a TRP event and has a high thermal requirement but does not need to meet normal operation water intrusion standards. For example, the outer seal may be formed from high thermal adhesive. Certain embodiments herein improve the serviceability of the battery pack by distancing adhesive that must be cut for opening the battery enclosure to locations away from vulnerable internal components of the battery pack.

In certain embodiments, the outer seal meeting the high thermal requirement is located away from high voltage components in the battery, thus the outer seal is serviceable, i.e., may be cut, without risking damage to battery components.

In certain embodiments, the battery enclosure system may be optimized for venting capability during TRP without unnecessarily adding numerous vent assemblies to compensate for membrane clogging.

Certain embodiments herein reduce spark arresting vulnerability to clogging. Certain embodiments herein improve flow capability by not allowing interference of a breathing membrane in current vents due to membrane obstructions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery enclosure system comprising:
a tray;
a cover;
an annular inner seal sealing the tray to the cover and defining an inner enclosed chamber and an annular outer enclosed channel; and
a battery located in the inner enclosed chamber.

2. The battery enclosure system of claim 1, wherein the annular inner seal is formed by a gasket.

3. The battery enclosure system of claim 2, further comprising an annular outer seal formed by adhesive and connecting a perimeter of the tray to a perimeter of the cover, wherein the annular outer enclosed channel is located between the annular inner seal and the annular outer seal.

4. The battery enclosure system of claim 3, wherein the annular inner seal is configured to fail at a first pressure and wherein the annular outer seal is configured to withstand the first pressure.

5. The battery enclosure system of claim 1, further comprising an outlet device in communication with the annular outer enclosed channel.

6. The battery enclosure system of claim 1, further comprising an outlet device formed in the cover and in communication with the annular outer enclosed channel.

7. The battery enclosure system of claim 1, further comprising an outlet device formed in the tray and in communication with the annular outer enclosed channel.

8. The battery enclosure system of claim 1, further comprising a manifold interconnected to the annular inner seal, wherein the annular outer enclosed channel is located between the annular inner seal and the manifold.

9. The battery enclosure system of claim 8, further comprising an outlet device formed in the manifold.

10. A method for venting gases from a battery, the method comprising:
locating the battery between a tray and a cover;
sealing the cover to the tray to form an annular inner seal enclosing an inner chamber, wherein the battery is located in the inner chamber, and wherein the annular inner seal separates the inner chamber from an annular outer enclosed chamber;
separating the cover from the tray at a failure location in the annular inner seal due to an increased pressure within the inner chamber;
flowing the gases from the inner chamber to the annular outer enclosed chamber at the failure location; and
flowing the gases out of the annular outer enclosed chamber through a particulate filter.

11. The method of claim 10, wherein the annular inner seal is formed by a gasket.

12. The method of claim 10, further comprising sealing a cover perimeter of the cover to a tray perimeter of the tray with an adhesive to form an annular outer seal, wherein the annular outer enclosed chamber is located between the annular inner seal and the annular outer seal.

13. The method of claim 12, wherein the annular inner seal is configured to fail at the increased pressure and wherein the annular outer seal is configured to withstand the increased pressure.

14. The method of claim 10, further comprising forming the particulate filter in the tray and/or cover at a selected location or coupling the particulate filter to the tray and/or cover at a selected location.

15. The method of claim 14, further comprising directing flow of the gases through the particulate filter in a desired direction.

16. A vehicle comprising:
a battery; and
a battery enclosure system comprising:
a tray having a tray perimeter;
a cover having a cover perimeter; and
an annular inner seal connecting the tray perimeter to the cover perimeter and defining an inner enclosed chamber and an annular outer enclosed chamber;
wherein the battery is located in the inner enclosed chamber.

17. The vehicle of claim 16, wherein the annular inner seal is formed by a gasket.

18. The vehicle of claim 17, wherein the battery enclosure system further comprises an annular outer seal formed by adhesive and connecting the tray perimeter to the cover perimeter, wherein the annular outer enclosed chamber is located between the annular inner seal and the annular outer seal.

19. The vehicle of claim 16, wherein the battery enclosure system further comprises a particulate filter in communication with the annular outer enclosed chamber.

20. The vehicle of claim 16, wherein the battery enclosure system further comprises a manifold interconnected to the annular inner seal, wherein the annular outer enclosed chamber is located between the annular inner seal and the manifold.
